(19) United States
(12) Patent Application Publication
(10) Pub. No.: US 2014/0365068 A1
(43) Pub. Date: Dec. 11, 2014

(54) Personalized Voice User Interface System and Method

(71) Applicants: Melvin Burns, Mundelein, IL (US); Wanda L. Burns, Mundelein, IL (US)

(72) Inventors: Melvin Burns, Mundelein, IL (US); Wanda L. Burns, Mundelein, IL (US)

(21) Appl. No.: 14/297,031

(22) Filed: Jun. 5, 2014

Related U.S. Application Data
(60) Provisional application No. 61/831,993, filed on Jun. 6, 2013.

(51) Int. Cl. G10L 13/033; G07C 5/00; G01C 21/36

(52) U.S. Cl. CPC G10L 13/033; G01C 21/3629; G01C 21/3608; G07C 5/008
USPC 701/31.5; 704/261; 704/2; 701/539

(57) ABSTRACT

The present invention is directed to a system and method for personalizing a voice user interface on an electronic device. Voice recordings are made into an electronic device or a computerized system using a software installed onto the device, where a user is prompted to record various dialogues and commands. The recording is then converted into voice data packages, and uploaded onto the electronic device. In this way, users can replace the computerized or preloaded voice in a voice user interface of an electronic device with their own voice or a voice of others. In one embodiment, the electronic device comprises a mobile phone or a tablet computer. In other embodiments, the electronic device comprises a vehicle communication system and a navigation device. The system and method of the present invention enables the user to personalize the voice user interface for each electronic device operated by the user.

### CROSS REFERENCE TO RELATED APPLICATION

This application claims the benefit of U.S. Provisional Application No. 61/831,993 filed on Jun. 6, 2013. The above identified patent application is herein incorporated by reference in its entirety to provide continuity of disclosure.

### BACKGROUND OF THE INVENTION

1. Field of the Invention

The present invention is directed to a personalized voice user interface system and method. More particularly, the present invention relates to a voice user interface of an electronic device and method of using the same, which dynamically records and transmits a recorded voice in place of a computerized or preloaded voice via computerized systems and electronic devices.

Personal digital assistants and navigators for operating systems on various electronic devices use a natural language user interface to answer questions, make recommendations, and perform actions by delegating requests to a set of web services. The application may adapt to the user's individual preferences and personalize results for the user. The natural language user interface generally utilizes computerized or preloaded voices of voice actors and actresses. These computer-generated or preloaded voices, however, are perfunctory, impersonal, and can be difficult to understand, especially for users from areas with distinct accents. As a result, users repeat the last verbal feedback, but it can be frustrating and difficult to have the device repeat itself constantly.

To resolve the problem of customizing an electronic device to make the voice user interface more understandable to the user, many devices offer multiple personalities and/or voices in a voice user interface in which a user can choose different voices to speak specific dialogues. These personalities and voices, however, are still limited to computerized or preloaded voices. While some of the alternative choices for personalities and voices may be more audibly pleasing to the user, these voices are impersonal to the user and may still be difficult to understand. As a result, the users are resorted to updating the operating systems on electronic devices to utilize new personalities and voices. This makes it difficult for users to personalize their electronic device to suit their preferences.

Additionally, many individuals prefer to listen to the voice of their friends or others instead of the preloaded voice through their personal electronic devices. Recorded voices are often keepsakes of others as familiar voices provide comfort to the user. Traditional voice user interface systems, however, do not enable a user to replace the computerized or preloaded voice with the voice of the user or others.

The instant invention comprises a system for using the user's voice of the voice of others in lieu of a computerized or preloaded voice on a voice user interface system of an electronic device. In one embodiment of the invention, the system utilizes a digital personal assistant system on a phone or a tablet computer. In other embodiments, the voice user interface system may be used with a vehicle communication system and a navigation device that includes a personalized voice turn by turn navigation system. These systems utilize voice control and audible feedback, increasing user interaction with the electronic device.

The present invention also comprises a method for replacing a computerized or preloaded voice with the voice of the user in a user voice interface system. This method generally comprises the steps of recording a user's voice directly onto an electronic device having a voice user interface system that utilize an intelligent personal digital assistant and a knowledge navigator. The method may further comprise the steps of converting the recorded voice into a voice data package. In addition, the method may further comprise the step of uploading the voice data package on an electronic device having a user voice interface system. As the device is exposed to more variations of a language, its overall recognition of dialects and accents improve, and allows the electronic device to work better. As will be described in further detail herein, there are many additional features of the instant invention.

2. Description of the Prior Art

Devices have been disclosed in the prior art that relate to turn-by-turn navigation voices and voice data as utilized with a variety of electronic devices. These include devices that have been patented and published in patent application publications, and generally relate to voice data packages that are integrated with an electronic device. Some of these devices describe natural language voice user interface that provide an integrated voice navigation services. Other devices describe a method and apparatus for creating and modifying navigation voice syntax. These devices, however, do not disclose a system and method that allows a user to replace a computerized or factory set voice on any electronic device, which helps personalize the device to the individual user's liking. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 8,370,147 to Kennewick discloses a system and method for providing a natural language voice user interface in an integrated voice navigation services environment. The voice user interface enables a user to use natural language to issue queries, commands, or other requests relating to the navigation services. The voice user interface may also interact with the user in a cooperative, conversational dialogue to resolve the requests. The system and method disclosed in Kennewick utilizes a conversational language processor that is interactive with a navigation application to perform a requested task. The voice user interface generates cross-modal intelligent responses having natural variation and personality. Additionally, the voice user interface may invoke a response generation application to advance the conversation.

Similarly, U.S. Pat. No. 7,831,433 to Belvin provides a system and method for using context in navigation dialog. Belvin discloses a speech understanding system that interacts with a speech generator. The speech understanding system is capable of receiving an input speech utterance from a user and converting the input speech utterance into an interpreted input utterance. The speech generator is configured to receive the phrase from the route guidance module of the navigational system and convert the phrase into an audible speech signal. The speech understanding system and the speech generator may be contained in a single computer processing unit (CPU) and run as separate processes or be distributed across multiple CPUs connected via an in-vehicle network.

While the foregoing systems and methods in Kennewick and Belvin are directed toward providing a natural dialogue with a user, the system and method of Kennewick and Belvin are limited in the fact that it does not allow the user to change the personality of the voice user interface. Moreover, neither of the prior arts disclose a system and method that allow the user to replace the voice user interface personality with the voice of the user or others. The present invention provides a system and method for recording the voice of the user or others, and converting the recorded voice into voice data packages. Thereafter, the user can upload the voice data packages onto an electronic device. In this way, the user is able to replace the computerized or factory set voice of a voice user interface, which allows a user to add his or her own personality to the device.

U.S. Published Patent Application No. 2009/0171665 to Hammerschmidt discloses a method and apparatus for creating and modifying navigation voice syntax. Hammerschmidt discloses a voice package that includes a language data base and a plurality of audio files. The language database specifies appropriate syntax and vocabulary for information that is intended for audio output by a position-determining device, such as a global positioning system (GPS). Hammerschmidt further disclose a voice package toolkit adapted to construct and/or customize one or more parts of a voice package by combining audio files that are generated from the syntax and/or vocabulary information in the voice package. Accordingly, a user may add audio files to the audio data or customize the particular syntax and/or vocabulary that the language database currently provides without affecting a change in the operating software used by the position-determining device. The audio files may include custom voices, such as a voice of a famous actor.

While Hammerschmidt discloses a method and apparatus for using custom voices, it does not allow a user to record his or her own voice and utilize the same in lieu of the pre-recorded voices. In contrast, the present invention allows a user to record his or her own voice or a voice of others and store it as a voice data package for uploading to a computerized system. In this way, the existing pre-recorded voice on the computerized system is no longer utilized. Additionally, the system and method of the present invention may be used for a variety of devices, including, but not limited to navigational devices.

U.S. Pat. No. 6,144,938 to Albert discloses a method and apparatus for utilizing a voice user interface with personality. The method includes executing a voice user interface, and controlling the voice user interface to provide the voice user interface with a personality. The voice user interface is capable of responding to a selected prompt based on various context situations. When controlling the voice user interface, the user can select a smooth hand-off prompt, polite prompt, or a negative prompt, among others. The voice user interface may act as a virtual assistant to the user. The voice user interface is created by recording a human voice reading a script of a dialogue, which involves directing an actor or actress selected to read the appropriate scripts. Conversely, the present invention provides voice prompts and on-screen display to indicate to the user the dialogue that needs to be recorded. Accordingly, Albert does not disclose a method and system that allows a user to record and utilize his or her own voice as a character voice for voice user interface. Therefore, Albert is inoperable to solve the problem solved by the present invention.

Finally, U.S. Pat. No. 8,412,457 to Lee discloses a method and apparatus for setting a desired destination in a navigational terminal, wherein the navigational terminal is linked to a mobile communication terminal. The mobile communication terminal includes a voice processing unit that recognizes spoken requests to complete tasks, such as making a phone call or recording audio. Unlike the present invention, however, Lee does not provide an interactive voice user interface that utilizes the voice of a user or others. Additionally, Lee does not enable the user to convert the recorded audio into a voice data package for uploading to the navigation system on a device.

These prior art methods and apparatus have several known drawbacks. They do not disclose a system that allows a user to replace a computerized or preloaded voice with the voice of the user or others. The present invention is a system and method for recording and uploading a recording of a user's voice or the voice of others for use with a voice user interface system on an electronic device that utilize an intelligent personal digital assistant and a knowledge navigator. The preferred implementation of the system employs an electronic device or a computerized system with voice recognition capabilities as the input means. Using the wireless protocol or other suitable short-range radio frequency data transmission protocol, the electronic device or the computerized system communicates directly with the input means. Users may speak a predetermined set of words or phrases to the input means, which then records the spoken words or phrases and converts it into voice data packages. Voice data packages are stored on a memory means within the electronic device or the computerized system and transmitted as an audible feedback in response to voice control.

It is therefore submitted that the present invention is substantially divergent in design elements from the prior art, and consequently it is clear that there is a need in the art for an improvement to existing voice data packages that are integrated with an electronic device. In this regard, the instant invention substantially fulfills these needs.

### SUMMARY OF THE INVENTION

In view of the foregoing disadvantages inherent in the known types of voice data packages that are integrated with an electronic devices now present in the prior art, the present invention provides a new system and method for personalizing a voice user interface on an electronic device, wherein the same can be utilized for replacing a computerized or preloaded voice on an electronic device with the voice of the user or others.

It is therefore an object of the invention to provide a new and improved system and method for personalizing a voice user interface on an electronic device that has all of the advantages of the prior art and none of the disadvantages.

It is another object of the present invention to provide a new and improved system and method for personalizing a voice user interface on an electronic device that replaces a computerized or preloaded voice with that of a user or others on an electronic device.

Another object of the present invention to provide a new and improved system and method for personalizing a voice user interface on an electronic device that may be used with a wide variety of electronic devices.

Yet another object of the present invention to provide a new and improved system and method for personalizing a voice user interface on an electronic device that enables a user to have an interactive dialogue with the device.

Still yet another object of the present invention to provide a new and improved system and method for personalizing a voice user interface on an electronic device that provides a long term storage for voice data packages created by a user.

Still yet another object of the present invention to provide a new and improved system and method for personalizing a voice user interface on an electronic device that translates voice data packages into various languages.

A final object of the present invention to provide a new and improved system and method for personalizing a voice user interface on an electronic device that utilizes a natural language of a user.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1A shows a flow diagram of an exemplary method for utilizing the system of the present invention on a mobile phone or a tablet computer via a software program or an application.

FIG. 1B shows a view of the present invention as used with a mobile phone and a tablet computer.

FIG. 2 shows a view of the present invention as used with a navigational device.

FIG. 3A shows a flow diagram of an exemplary method for utilizing the system of the present invention with a subscription based or non-subscription based vehicle communication system that includes in-vehicle security, hands free calling, turn-by-turn navigation, and remote diagnostics system.

FIG. 3B shows a view of the present invention as used with a subscription based vehicle communication system.

FIG. 3C shows a view of the present invention as used with a vehicle communication system.

### DETAILED DESCRIPTION OF THE INVENTION

References is made herein to the attached drawings. Like reference numerals are used throughout the drawings to depict like or similar elements of the system and method for personalizing a voice user interface on an electronic device. For the purposes of presenting a brief and clear description of the present invention, the preferred embodiment will be discussed as used for replacing a computerized or preloaded voice on an electronic device. The figures are intended for representative purposes only and should not be considered to be limiting in any respect.

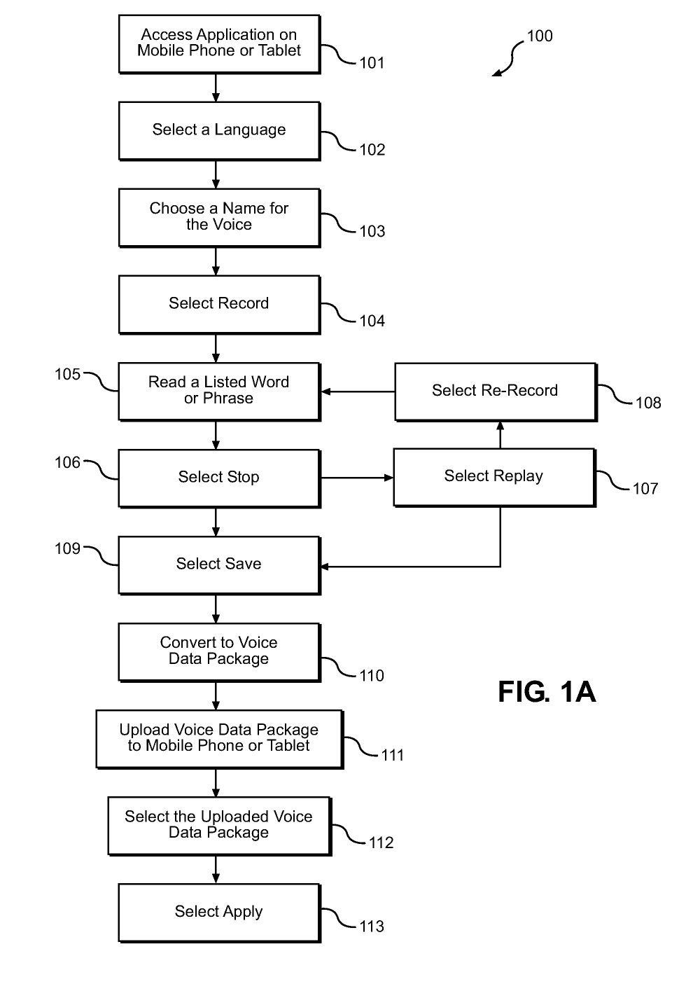

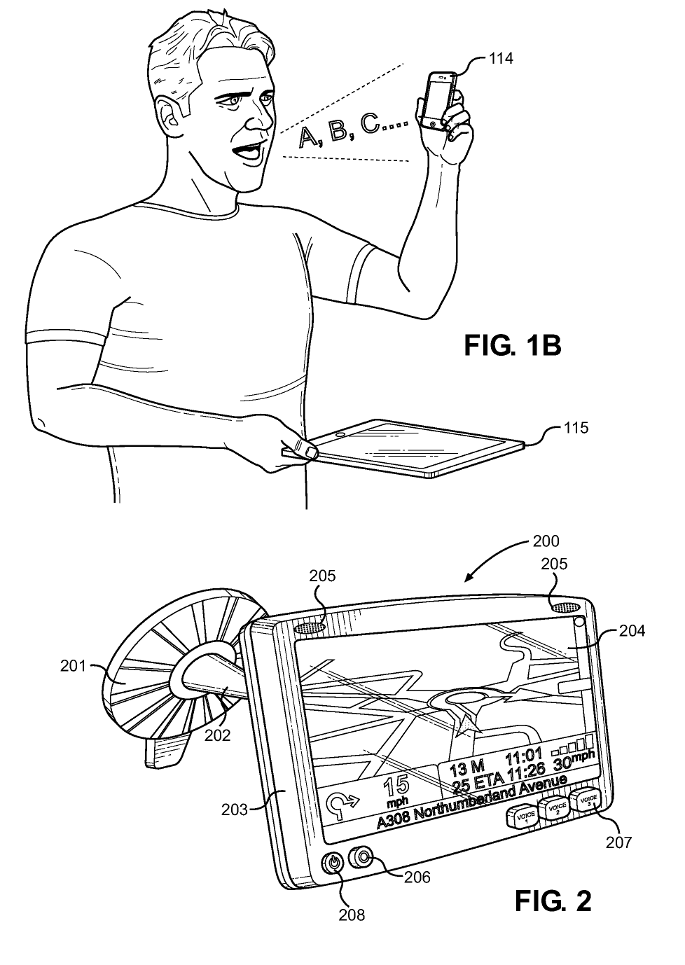

Referring now to FIG. 1A, there is shown a flow diagram of an exemplary method 100 for utilizing the system of the present invention on a mobile phone or a tablet computer via a software program or an application. The program or the application is downloaded onto the user's mobile phone or tablet computer, then accessed by opening the program or the application 101. The user then selects a language that the user wishes to record on the device 102. Without limitation, the user may select Chinese, Spanish, English, Arabic, Hindi, Bengali, Portuguese, Russian, Japanese, German, Javanese, Lahnda, Telugu, Vietnamese, Marathi, French, Korean, Tamil, Italian, and Urdu. Alternatively, the user may record various words and phrases in one language, which may later be translated into a different language in the user's voice via the program or the application. More specifically, the present system will split and combine tonation and syllables of the words and phrases in the voice recordings to generate words and phrases in a different language in the user's voice or the voice of others.

The user then selects a name for the recording 103. For instance, the name of the recording could correspond with the name of the user whose voice is being recorded. When the user is ready to start recording, the user selects the record button 104 to initiate voice recording directly onto the phone or the tablet. The user then proceeds to read a listed word or a phrase 105 that is utilized by the electronic device's system. Some of the voice records may be imperative or declarative. In some embodiments, the program or the application is able to identify different words or phrases by detecting the silence between the words or phrases. In this way, it is preferable that the user reads each word or phrase one at a time so as to allow the user to pronounce each word or phrase clearly. It is contemplated that the present system will split and combine tonation and syllables of the words and phrases in the voice recordings to generate new phrases and words that were not among the listed words or phrases. After each word or a phrase, the user can stop the recording 106.

Optionally, the user may replay the recording 107 so as to ensure that the word or phrase was recorded correctly. If the word or phrase was not recorded correctly, the user can re-record 108 and read the previously listed word or phrase 105 again. When the user has completed recording the listed words or phrases provided, the user can save the recording 109. Thereafter, the recording is converted to a voice data package 110 and uploaded onto the phone or the tablet 111. The user may then select the uploaded voice data package 112 by selecting the name of the recording, and applying the changes made 113.

Applying the changes would allow the device to utilize the voice from the recording when utilizing voice user interface instead of the computerized or preloaded voice. In one embodiment, the user may turn off or deactivate the existing computerized or preloaded voice on the user's phone or tablet so that only the voices used to create voice data packages are used for any audible feedback. Thereafter, the phone or tablet leverages its voice recognition functionality to enable the user to speak a command or inquiry and receive an audible feedback. Alternatively, the user may enter a command or inquiry via an alphanumeric keypad of the device to receive an audible feedback. In this way, the present invention allows the user to hear his or her own voice or the voice of others.

Referring now to FIG. 1B, there is shown an embodiment of the present invention as used with a mobile phone 114 and a tablet computer 115 via a software program or an application. The phone 114 or the tablet computer 115 preferably comprises a display screen, imbedded memory and computer processing unit, an internal power source, a speaker, and voice recording means such as a microphone. In operation, the phone 114 or the tablet computer 115 has voice recognition capabilities as the input means. Using the wireless protocol or other suitable short-range radio frequency data transmission protocol, the phone 114 or the tablet computer 115 communicates directly with the input means. The user may speak a predetermined set of words or phrases to the input means, which then records the spoken words or phrases and converts it into voice data packages. Alternatively, the user may record voices of others. Voice data packages are stored on a memory means within the phone 114 or the tablet computer 115 and transmitted as an audible feedback in response to the user's voice input. The user may also control various operation of the phone 114 or the table computer 115 via the display screen with touch capability or control buttons disposed on the phone 115 or the tablet computer 115.

Referring now to FIG. 2, there is shown a view of a navigational device 200 that utilizes the personalized voice user interface system of the present invention. The navigational device 200 comprises a portable housing 203 with an imbedded computer processing unit, memory, battery power, and necessary internal circuitry of a navigation component, a power button 208 that controls operation of the device, a record button 206 that records a user's voice, and voice selection buttons 207 that allows a user to select a desired voice. In a preferred embodiment, the navigational device 200 is adapted to record and store three different voice recordings. Accordingly, the voice selection buttons 207 may be labeled “Voice 1,” “Voice 2,” and “Voice 3.” Additionally, the navigational device 200 comprises a preloaded voice recording that may be used as a default.

The front side of the housing 203 comprises a display screen 204, which may be a touch screen, and speakers to emit audio recordings. The touch screen is also adapted to allow a user to control various operation of the device, such as volume control, brightness and contrast adjustment, and the like. The rear side of the housing comprises a mounting assembly having an elongated body 202 and a suction cup 201 attached thereto. In this way, the device 200 may be mounted onto a vehicle windshield, or other substantially upright surfaces as desired by a user.

The navigational device 200 of the present invention utilizes a satellite-based navigation system such as GPS and is capable of displaying maps on the display screen 204, providing audio and visual turn-by-turn navigation, and providing information on nearby amenities such as restaurants, fueling stations, and tourist attractions. The device 200 is further adapted to provide information regarding the roads or paths available, traffic congestion and alternative routes, best routes, the location of places of interests, the shortest route between the two locations, different options to drive on highway or back roads. The user may communicate with the device 200 using its voice recognition capabilities. The user may speak a predetermined set of words and phrases, and the device 200 may provide audible feedback in response.

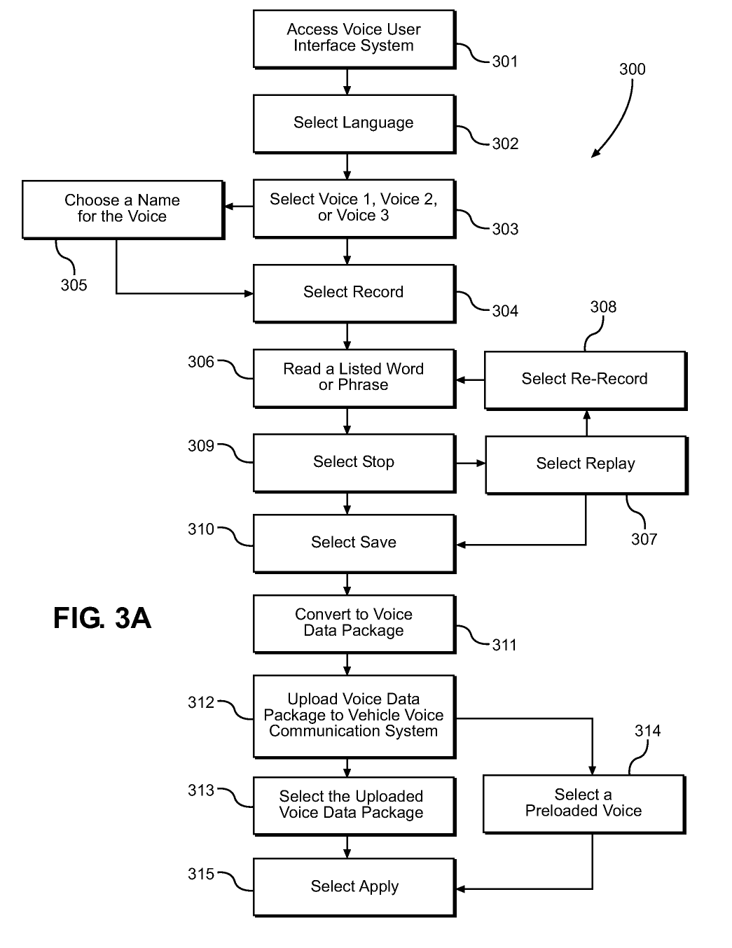

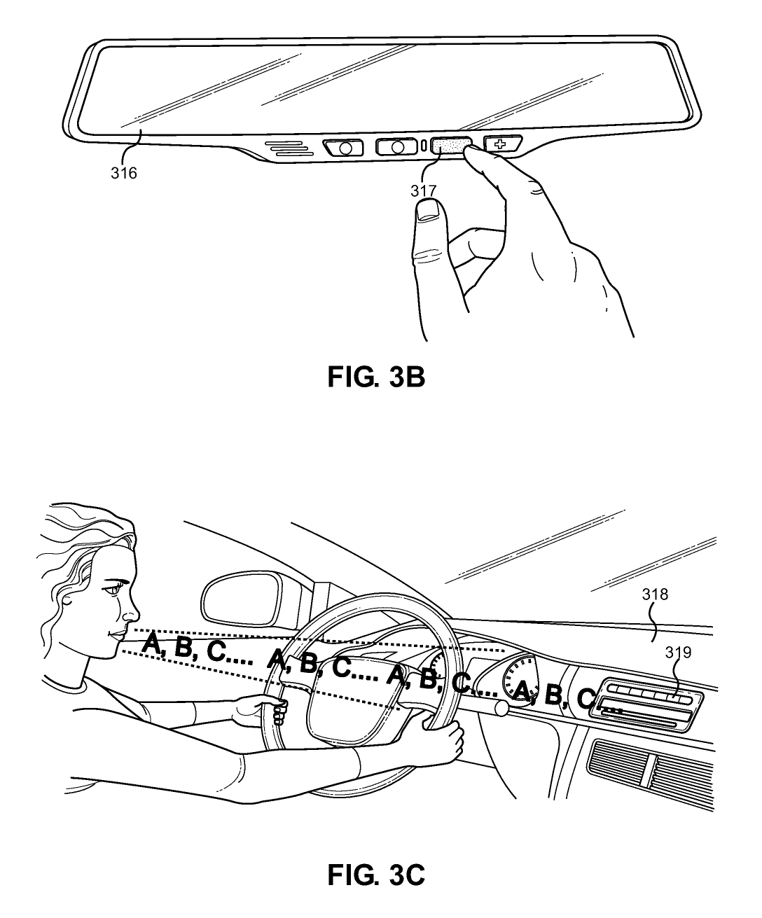

Referring now to FIG. 3A, there is shown a flow diagram of an exemplary method for utilizing the system of the present invention with a subscription based or non-subscription based vehicle communication system that includes in-vehicle security, hands free calling, turn-by-turn navigation, and remote diagnostics system. The personalized voice user interface system is preferably integrated with a vehicle in which it is used. The system is accessible through the dashboard control panel of the vehicle 301. In some embodiments, the user may select a language that the user wishes to record 302. Without limitation, the user may select Chinese, Spanish, English, Arabic, Hindi, Bengali, Portuguese, Russian, Japanese, German, Javanese, Lahnda, Telugu, Vietnamese, Marathi, French, Korean, Tamil, Italian, and Urdu. Alternatively, the user may record various words and phrases in one language, which may later be translated into a different language in the user's voice via the software program or the application. More specifically, the present system will split and combine tonation and syllables of the words and phrases in the voice recordings to generate words and phrases in a different language in the user's voice or the voice of others.

The user then selects whether the recording would be a first voice data package, second voice data package, or third voice data package by selecting “Voice 1,” “Voice 2,” or “Voice 3,” respectively 303. Additionally, the user may name the voice recording 305. The name of the recording could correspond with the name of the user whose voice is being recorded so that the user may easily identify each of the voice data packages stored. When the user is ready to start recording, the user selects the record button 304 to initiate voice recording. The user then proceeds to read a listed word or a phrase 306 that is utilized by the electronic device's operating system. For example, the user may record phrases for turn-by-turn navigation such as: “turn right onto . . . ”; “turn left onto . . . ”; “your destination is ahead on the right”; “your destination is ahead on the left”; “In 500 feet, turn left onto . . . ”; “make a U-turn”; “exit”; “merge onto . . . ”; “keep right”; “keep left.”

In some embodiments, the system is able to identify different words or phrases by detecting the silence between the words or phrases. Thus, it is preferable that the user reads each word or phrase one at a time so that the present system can record each word or phrase in a clear and distinct manner. After each word or a phrase, the user can stop the recording 309. Optionally, the user may replay the recording 307 so as to ensure that the word or phrase was recorded correctly. If the word or phrase was not recorded correctly, the user can re-record 308 and read the previously listed word or phrase 306 again. When the user has completed recording the listed words or phrases provided, the user can save the recording 310. It is contemplated that the present system will split and combine tonation and syllables of the words and phrases in the voice recordings to generate new phrases and words that were not among the listed words or phrases. Thereafter, the recording is converted to a voice data package 311 and uploaded onto the vehicle voice communication system 312. The user may then select the uploaded voice data package 313 by selecting the name of the recording, and applying the changes made 315. Alternatively, the user may select a preloaded voice 314 and apply the changes made 315.

Applying the changes allows the vehicle communication system to utilize the voice from the recording instead of the computerized or preloaded voice. The vehicle communication leverages its voice recognition functionality to enable the user to speak a command or inquiry and receive an audible feedback. Alternatively, the user may enter a command or inquiry via control buttons or an alphanumeric keypad on the dashboard control panel to receive an audible feedback. In this way, the present invention allows the user to hear his or her own voice or the voice of others while using a vehicle communication system.

FIG. 3B shows a view of the present invention as used with a subscription based vehicle communication system via a software program or an application. In the illustrated embodiment, the present invention comprises a control button 317 disposed on a rear view mirror 316. The control button 317 executes the personalized voice user interface system. In operation, the present system is adapted to replace a preloaded voice that is used with in-vehicle security, hands free calling, turn-by-turn navigation, remote diagnostics system, and the like. As such, any audible feedback relayed from the subscription based vehicle communication system utilizes the user's voice or the voice of others contained in voice data packages.

The user may select a desired voice data package using the dashboard control panel having a display screen with touch capabilities or control buttons. The display screen is adapted to list the voice selections available for use with the subscription based vehicle communication system. Preferably, the user may select from one of three voice selections or a preloaded voice. The present invention increases the efficiency of the communication between the user and the vehicle communication system by accommodating to the user's diction and natural language.

FIG. 3C shows a view of the present invention as used with an existing vehicle communication system via a software program or an application having the present voice user interface system integrated therewith. In operation, the user accesses the voice user interface via a dashboard control panel comprising a display screen. The display screen preferably has touch capability so as to provide the user with selection means. In some embodiments, the dashboard control panel may further comprise a plurality of control buttons to further operate the same.

The display screen is adapted to list different voice selections, as well as one or more preloaded voices. For instance, the display screen may show, “Voice 1,” “Voice 2,” “Voice 3,” and “Default,” thereby allowing the user to select one of the voices for audible feedback. If the voice selection does not contain a voice data package, the user may be prompted to create a new voice data package using the exemplary method described above. If the voice selection contains a voice data package, the selected voice is utilized in place of the preloaded voice for all audible feedback.

The vehicle communication system has voice recognition capabilities as the input means. Using the wireless protocol or other suitable short-range radio frequency data transmission protocol, the vehicle communication system communicates directly with the input means via a processing unit. The user may say a command or an inquiry to the input means through a microphone. The command or the inquiry is then recorded and the processing unit converts it into voice data packages. Alternatively, the user may record voices of others. Voice data packages are stored on a memory means within the vehicle communication system and transmitted as an audible feedback through the vehicle speakers in response to the user's voice input through the microphone. The user may also control various operation of the vehicle communication system via the display screen of the dashboard control panel with touch capability or control buttons.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A personalized voice user interface system, comprising:
an electronic device having at least one computer processing unit and at least one memory unit;
said at least one computer processing unit adapted to receive a voice recording and convert said voice recording to a voice data package;
said at least one memory unit adapted to store said voice data package;
said at least one computer processing unit adapted to receive a command and generate an audible feedback using said voice data package.

2) The personalized voice user interface system of claim 1, wherein said at least one computer processing unit is further adapted to convert said voice data package into a different language.

3) The personalized voice user interface system of claim 1, wherein said voice recording comprises a voice of a user or others.

4) The personalized voice user interface system of claim 1, wherein said electronic device is a phone.

5) The personalized voice user interface system of claim 1, wherein said electronic device is a computer tablet.

6) The personalized voice user interface system of claim 1, wherein said electronic device is a navigational device.

7) The personalized voice user interface system of claim 1, wherein said electronic device is a vehicle communication system.

8) A method of personalizing a voice user interface system of an electronic device, comprising the steps of:
recording words and phrases by a user corresponding to a predetermined set of words and phrases;
converting said voice recording to a voice data package;
uploading said voice data package to an electronic device;
selecting said voice data packages on said electronic device;
applying changes on said electronic device, wherein applying changes on said device replaces a preloaded voice with said voice data package on said electronic device.

9) The method of personalizing a voice user interface system of an electronic device of claim 8, wherein said electronic device is a phone.

10) The method of personalizing a voice user interface system of an electronic device of claim 8, wherein said electronic device is a computer tablet.

11) The method of personalizing a voice user interface system of an electronic device of claim 8, wherein said electronic device is a navigational device.

12) The method of personalizing a voice user interface system of an electronic device of claim 8, wherein said electronic device is a vehicle communication system.

13) A software program embodied on an electronic device medium and comprising code that, when executed by a computer processing unit on said electronic device, enables said electronic device to perform the following method:
recording words and phrases by a user corresponding to a predetermined set of words and phrases;
converting said voice recording to a voice data package;
uploading said voice data package to an electronic device;
selecting said voice data packages on said electronic device;
applying changes on said electronic device, wherein applying changes on said device replaces a preloaded voice with said voice data package on said electronic device.

14) The software program of claim 13, wherein said electronic device is a phone.

15) The software program of claim 13, wherein said electronic device is a computer tablet.

16) The software program of claim 13, wherein said electronic device is a navigational device.

17) The software program of claim 13, wherein said electronic device is a vehicle communication system.
